(19) United States
(12) Patent Application Publication
(10) Pub. No.: US 2014/0222425 A1
(43) Pub. Date: Aug. 7, 2014

(54) SPEECH RECOGNITION LEARNING METHOD USING 3D GEOMETRIC INFORMATION AND SPEECH RECOGNITION METHOD USING 3D GEOMETRIC INFORMATION

(71) Applicant: SOGANG UNIVERSITY RESEARCH FOUNDATION, Seoul (KR)

(72) Inventors: Hyung-Min PARK, Seoul (KR); Changsoo JE, Seoul (KR); Bi Ho KIM, Yeosu-si (KR); Min Wook KIM, Goyang-si (KR)

(73) Assignee: SOGANG UNIVERSITY RESEARCH FOUNDATION, Seoul (KR)

(21) Appl. No.: 14/174,926

(22) Filed: Feb. 7, 2014

(30) Foreign Application Priority Data
Feb. 7, 2013 (KR) 10-2013-0013854

(51) Int. Cl. G10L 15/06

(52) U.S. Cl. CPC G10L 15/063
USPC 704/243

(57) ABSTRACT

Provided are a speech recognition learning method using 3D geometric information and a speech recognition method by using 3D geometric information. The method performs learning by using 3D geometric information for learning or information derived from the 3D geometric information to generate a recognizer, and the speech recognition method performs speech recognition by applying 3D geometric information on a physical object correlated to or dependent on voice or information derived from the 3D geometric information to the recognizer.

### BACKGROUND OF THE INVENTION

1. Field of the Invention

The present invention relates to a speech recognition learning method and a speech recognition method using 3D geometric information, and more particularly, to a speech recognition learning method and a speech recognition method capable of more accurately performing speech recognition by performing speech recognition learning or performing speech recognition by using 3D geometric information on a physical object correlated to or dependent on speech or information derived from the 3D geometric information.

2. Description of the Prior Art

Speech recognition has been implemented mainly based on acoustic signal. However, in an excessively noisy environment or in a handicapped hearing situation, there have been used methods of estimating speech from information on outer appearance such as lips and tongue or images thereof. In addition, in order to improve accuracy of the speech recognition, a multi-modal based speech recognition research, and particularly, an integrated audiovisual speech recognition search have been made (Matthews, lain, et al. “Extraction of visual features for lipreading.” Pattern Analysis and Machine Intelligence, IEEE Transactions on 24.2 (2002): 198-213).

In noisy environments such as outdoors, factories, or car driving environments, it is suitable to use image information which is not influenced by acoustic noise.

In a visual speech recognition method based on images in the related art, speech recognition has been performed by using 2D feature information extracted from 2D image of lips of a speaker. However, geometric changes of lips and the peripheries of the speaker are not limited to 2D geometric changes. In general, 3D geometric changes occur in lips and the peripheries during speaking.

In this manner, since speech recognition techniques in the related art perform speech recognition without consideration of 3D geometric changes of lips, face, and other portions of the body, there is a problem in that accuracy of speech recognition is low.

### SUMMARY OF THE INVENTION

The present invention is to provide a speech recognition learning method of performing speech recognition learning by using 3D geometric information on a physical object correlated to or dependent on speech or information derived from the 3D geometric information.

The present invention is also to provide a speech recognition learning method of performing speech recognition learning by using 3D geometric information on a physical object correlated to or dependent on speech or information derived from the 3D geometric information, acoustic information and/or 2D information.

The present invention is also to provide a speech recognition method of performing speech recognition by using 3D geometric information on a physical object correlated to or dependent on speech or information derived from the 3D geometric information. The present invention is also to provide a speech recognition method of performing speech recognition by using 3D geometric information on a physical object correlated to or dependent on speech or information derived from the 3D geometric information, acoustic information and/or 2D information.

According to a first aspect of the present invention, there is provided a speech recognition learning method including performing speech recognition learning by using 3D geometric information on a physical object correlated to or dependent on speech or information derived from the 3D geometric information to generate a speech recognizer, wherein the 3D geometric information includes at least one or more of information on 3D point, information on 3D curve, and information on 3D surface.

According to a second aspect of the present invention, there is provided a speech recognition method including performing speech recognition by applying 3D geometric information on a physical object correlated to or dependent on speech or information derived from the 3D geometric information in a speech recognizer, wherein the 3D geometric information includes at least one or more of information on 3D point, information on 3D curve, and information on 3D surface.

According to a third aspect of the present invention, there is provided a speech recognition method (a) performing speech recognition learning by using 3D geometric information on a physical object correlated to or dependent on speech or information derived from the 3D geometric information to generate a speech recognizer, and (b) performing speech recognition by applying the 3D geometric information on the physical object correlated to or dependent on speech or the information derived from the 3D geometric information to the speech recognizer, wherein the 3D geometric information includes at least one or more of information on 3D point, information on 3D curve, and information on 3D surface.

In the speech recognition learning method according to the first aspect, preferably, the performing speech recognition learning is: performing the speech recognition learning by using the 3D geometric information or the information derived from the 3D geometric information and 2D features extracted from 2D image of the physical object; performing the speech recognition learning by using the 3D geometric information or the information derived from the 3D geometric information and acoustic signal correlated to or dependent on the physical object; or performing the speech recognition learning by using the 3D geometric information or the information derived from the 3D geometric information, 2D features extracted from 2D image of the physical object, and acoustic signal correlated to or dependent on the physical object.

In the speech recognition learning method according to the first aspect, preferably, the performing speech recognition learning is performing the speech recognition learning by using deep learning.

In the speech recognition method according to the second or third aspects, preferably, the performing speech recognition is: performing the speech recognition by using the 3D geometric information or the information derived from the 3D geometric information and 2D features extracted from 2D image of the physical object; performing the speech recognition by using the 3D geometric information or the information derived from the 3D geometric information and acoustic signal correlated to or dependent on the physical object; or performing the speech recognition by using the 3D geometric information or the information derived from the 3D geometric information, 2D features extracted from 2D image of the physical object, and acoustic signal correlated to or dependent on the physical object.

In a speech recognition learning method according to the present invention, speech recognition learning is performed by using 3D geometric information on a physical object correlated to or dependent on speech or information derived from the 3D geometric information, so that it is possible to improve accuracy of speech recognition.

In addition, in a speech recognition learning method according to the present invention, speech recognition learning is performed by using 3D geometric information or information derived from the 3D geometric information, acoustic features extracted from acoustic signal and/or 2D features derived from 2D image, so that it is possible to further improve accuracy of speech recognition.

In addition, in a speech recognition method according to the present invention, speech recognition is performed by using 3D geometric information on a physical object correlated to or dependent on speech or information derived from the 3D geometric information, so that it is possible to improve accuracy of speech recognition.

In addition, in a speech recognition method according to the present invention, speech recognition is performed by integrating 3D geometric information or information derived from the 3D geometric information and acoustic features extracted from acoustic signal, and/or 2D features extracted from 2D image, so that it is possible to further improve accuracy of speech recognition.

In addition, in a speech recognition method according to the present invention, speech recognition learning is performed by integrating 3D geometric information or information derived from the 3D geometric information and acoustic features derived from acoustic signal and/or 2D features extracted from 2D image and speech recognition is performed, so that it is possible to further improve accuracy of speech recognition.

### BRIEF DESCRIPTION OF THE DRAWINGS

FIG. 1 is a block diagram illustrating a speech recognition system according to an embodiment of the present invention.

FIG. 2 is diagrams illustrating examples of various techniques for acquiring 3D geometric information; FIG. 2(a) illustrates a structured light vision scheme; FIG. 2 (b) illustrates a typical active stereo vision scheme; and FIG. 2(c) illustrates a combinational scheme of the structured light vision scheme and the active stereo vision scheme.

FIG. 3 is a diagram illustrating depth images of speeches of ‘ah’, ‘eh’, ‘ee’, ‘um’ ‘oh’, ‘oo’ as examples of depth images of lips and neighboring portions for speech recognition in a speech recognition system according to an embodiment of the present invention.

FIG. 4 is a schematic diagram for explaining deep learning.

FIGS. 5 to 13 are diagrams illustrating speech recognition systems embodied by using the speech recognition learning method and the speech recognition method according to the embodiment of the present invention.

### DETAILED DESCRIPTION OF THE INVENTION

A speech recognition learning method and a speech recognition method according to embodiments of the present invention are to perform speech recognition learning using 3D geometric information or information derived from the 3D geometric information or to perform speech recognition.

Hereinafter, a speech recognition learning method and a speech recognition method according to embodiments of the present invention will be described in detail with reference to the attached drawings.

### <Speech Recognition System, Speech Recognition Method, and Speech Recognition Learning Method Using 3D Geometric Information>

A speech recognition system according to an embodiment of the present invention is to perform speech recognition learning using 3D geometric information on a physical object correlated to or dependent on speech or information derived from the 3D geometric information, and to perform speech recognition.

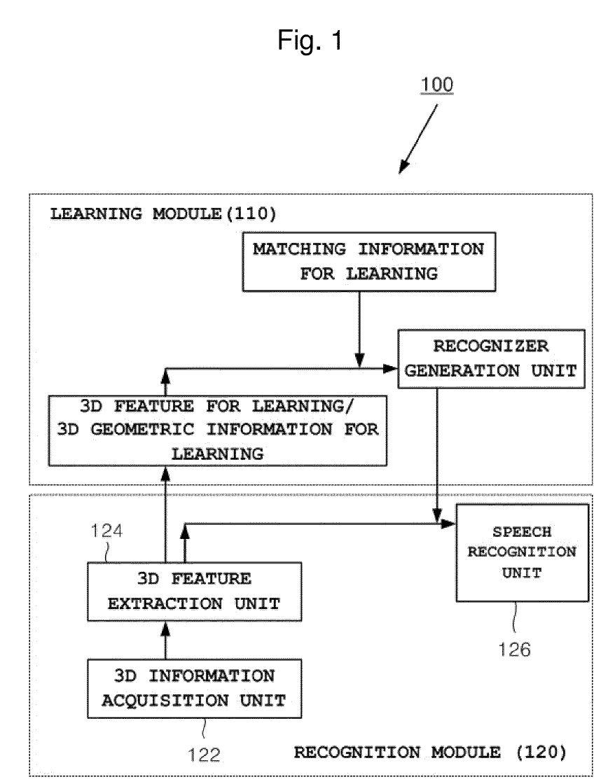

FIG. 1 is a block diagram illustrating a speech recognition system according to an embodiment of the present invention. Hereinafter, the speech recognition system and method according to the embodiment of the present invention will be described in detail with reference to FIG. 1.

Referring to FIG. 1, a speech recognition system 100 according to the embodiment of the present invention is configured to include a learning module 110 and a recognition module 120.

The learning module 110 generates a recognizer by using 3D geometric information for learning itself or by using extracting information derived from the 3D geometric information for learning and using the extracted information or the 3D geometric information for learning and matching information for learning. In the case of generating a recognizer by using the 3D geometric information for learning, it is possible to effectively reduce dimensions of features by using a method such as PCA (principal component analysis) or LDA (linear discriminant analysis). The recognizer can be generated by using well-known GMM (Gaussian mixture model), NN (nearest neighbor) algorithm, k-NN (k-nearest neighbor) algorithm, or the like; and various other algorithms can be used.

The 3D geometric information includes at least one or more of 3D point, 3D curve, and 3D surface.

The matching information for learning is generated by persons, machines, or software and includes intuitive or statistic correspondence between input and output recognition data.

The recognition module 120 acquires 3D geometric information on a physical object correlated to or dependent on speech and performs speech recognition by applying the 3D geometric information or information derived from the 3D geometric information to the recognizer. The 3D geometric information includes one or more of 3D point, 3D curve, and 3D surface.

The physical object correlated to or dependent on speech is a portion of a human body, or a portion of a machine (for example, a humanoid) emulating a portion of a human body or a motion of a human body, or a portion of clothes which a person or a machine (emulating a portion of a human body or a motion of a human body) wears (for example, lips, teeth, a tongue, cheeks, a chin, eyes, eyebrows, or hands of a human, or any of those of a humanoid, or gloves or a mask).

In the entire specification of the present invention, the physical object correlated to or dependent on speech, the 3D geometric information, the 3D geometric information on a physical object correlated to or dependent on speech, the matching information for learning are used to have the same meanings as described above, and thus, the redundant description thereof will be omitted hereinafter.

The matching information for learning of the learning module denotes speech information matching with the 3D geometric information for learning or the information derived from the 3D geometric information. The learning module generates a recognizer by using the 3D geometric information for learning or the information extracted from the 3D geometric information for learning, and the matching information for learning.

The recognition module 120 is configured to include a 3D information acquisition unit 122 which acquires 3D geometric information on the physical object, a 3D feature extraction unit 124 which extracts 3D features from the 3D geometric information acquired by the 3D information acquisition unit, and a speech recognition unit 126 which performs speech recognition by applying the 3D geometric information or the information derived from the 3D geometric information to the recognizer.

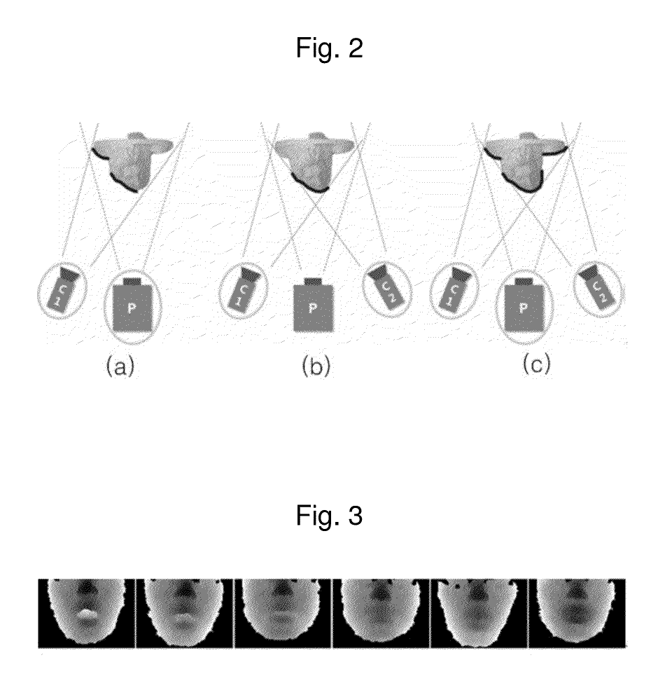

The 3D information acquisition unit 122 is configured to include a 3D information input unit which receives the 3D geometric information on the physical object externally input or a 3D geometric information estimation unit which directly estimates the 3D geometric information on the physical object. In the case where the 3D information acquisition unit 122 includes the 3D geometric information estimation unit, the 3D geometric information estimation unit may be configured to include one or more of existing various range sensors and depth sensors; and as representative measurement methods, there are a stereo vision scheme, a structured light scheme, and the like. FIGS. 2A to 2C are diagrams illustrating examples of various techniques for acquiring 3D geometric information; FIG. 2(a) illustrates a structured light vision scheme; FIG. 2(b) illustrates a typical active stereo vision scheme; and FIG. 2(c) illustrates a combinational scheme of the structured light vision scheme and the active stereo vision scheme.

FIG. 3 is a diagram illustrating depth images of speeches of ‘ah’, ‘eh’, ‘ee’, ‘um’, ‘oh’, ‘oo’ as examples of depth images of lips and neighboring portions for speech recognition in a speech recognition system according to an embodiment of the present invention.

In the speech recognition system according to the embodiment, a speech recognition learning method is embodied by a learning module; and a speech recognition method is embodied by a recognition module. In the embodiment, the speech recognition learning method embodied by the learning module is to generate a recognizer by using 3D geometric information for learning and matching information for learning or by using 3D features for learning extracted from the 3D geometric information for learning and matching information for learning. On the other, in the embodiment, the speech recognition method embodied by the recognition module is to perform speech recognition by applying the 3D geometric information on the physical object or information derived from the 3D geometric information to the recognizer.

### <Speech Recognition Learning Method and Speech Recognition Method Using 3D Geometric Information and 2D Features>

The speech recognition learning method and the speech recognition method according to the embodiment are to perform speech recognition learning or speech recognition by using 3D geometric information on a physical object correlated to or dependent on speech or information derived from the 3D geometric information and 2D image.

The speech recognition learning method according to the embodiment generates a feature vector for learning by integrating 2D features for learning and 3D geometric information for learning or information derived from the 3D geometric information for learning and generates a recognizer by using the feature vector for learning and matching information for learning.

The speech recognition method according to the embodiment generates a feature vector by integrating 3D geometric information on a physical object correlated to or dependent on speech or information derived from the 3D geometric information and 2D features extracted from 2D image of the physical object and recognizes the speech by applying the feature vector to the recognizer.

The 2D features for learning of the learning module denote 2D features for learning extracted from 2D image for learning; and the matching information for learning denotes speech information matching with 3D features for learning, 2D features for learning, and 3D geometric information for learning. The learning module generates a feature vector for learning by integrating 2D features for learning and 3D features for learning and generates a recognizer by using the feature vector for learning and the matching information for learning.

The speech recognition method acquires 3D geometric information on the physical object, extracts information derived from the acquired 3D geometric information, acquires 2D image of the physical object, extracts 2D features from the acquired 2D image, generates a feature vector by integrating the extracted 2D features and 3D geometric information or the aforementioned information, and recognizes speech by applying the feature vector to the recognizer.

### <Speech Recognition Learning Method and Speech Recognition Method Using 3D Geometric Information and Acoustic Feature>

The speech recognition learning method and the speech recognition method according to the embodiment are to perform speech recognition learning or to perform speech recognition by using 3D geometric information on a physical object correlated to or dependent on speech or information derived from the 3D geometric information and acoustic features extracted from acoustic signal.

The speech recognition learning method according to the embodiment is to generate a feature vector for learning by integrating acoustic features for learning extracted from acoustic signal for learning and 3D geometric information for learning or information derived from the 3D geometric information for learning and to generate a recognizer by using the feature vector for learning and matching information for learning.

The speech recognition method according to the embodiment is configured to include: a step of acquiring 3D geometric information on the physical object; a step of extracting information derived from the 3D geometric information; receiving acoustic signal externally input from an acoustic signal input unit; a step of extracting acoustic features from the acoustic signal input from the acoustic signal input unit; and a step of generating a feature vector by integrating the 3D geometric information or the information derived from the 3D geometric information and the acoustic features and recognizing speech by applying the feature vector to the recognizer.

### <Speech Recognition System Using 3D Geometric Information, 2D Features, and Acoustic Features>

The speech recognition learning method and the speech recognition method according to the embodiment are to perform speech recognition learning or to perform speech recognition by using 2D image of a physical object correlated to or dependent on speech, 3D geometric information, and acoustic signal.

The speech recognition learning method according to the embodiment is to generate a feature vector for learning by integrating acoustic features for learning extracted from acoustic signal for learning, 3D geometric information for learning, or information extracted from the 3D geometric information for learning, and 2D features for learning extracted from 2D image for learning and to generate a recognizer by using the feature vector for learning and matching information for learning.

The speech recognition method according to the embodiment is configured to include: a step of acquiring 3D geometric information on the physical object; a step of extracting information from the acquired 3D geometric information; a step of acquiring 2D image of the physical object and extracting 2D features from the acquired 2D image; a step of receiving acoustic signal externally input from an acoustic signal input unit; a step of extracting acoustic features from the acoustic signal input from the acoustic signal input unit; and a step of generating a feature vector by integrating the 3D geometric information or the information derived from the 3D geometric information, the 2D features, and the acoustic features and recognizing speech by applying the feature vector to the recognizer.

The speech recognition method according to the embodiment may be implemented by appropriately combining one of the aforementioned speech recognition learning methods and one of the aforementioned speech recognition methods according to various embodiments.

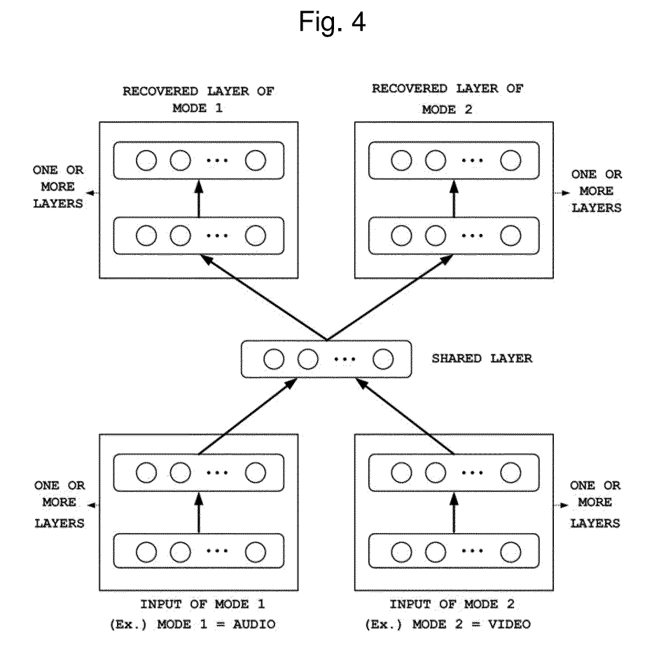

Hereinafter, a process of acquiring integrated feature of acoustic signal and image by using a multi-modal deep learning scheme in the aforementioned speech recognition learning methods according to the embodiment will be described in detail. FIG. 4 is a schematic diagram for explaining deep learning. The aforementioned speech recognition learning methods are to perform speech recognition learning by using deep learning through one of or a combination of DNN (Deep Neural Network), DBN (Deep Belief Network), and DCN (Deep Convolutional Network).

Referring to FIG. 4, it is possible to acquire more efficient feature by integrating acoustic and image features in feature level by using deep learning.

The deep learning denotes integrated learning in a learning structure of which number of learning layers is three or more. First, in a pre-training step, learning in a basic learning structure is performed through an RBM (Restricted Boltzmann Machine); in an unrolling step, a deep autoencoder is generated; and in a fine tuning step, deep learning is completed. Correlation between components can be more effectively described by deep learning than by PCA or shallow learning. As illustrated in FIG. 4, in the case of multi-modal deep learning based on acoustic signal (audio input) and image signals (video input), results of deep learning with respect to the signals are integrated to form feature layers. At this time, dimensional efficiency of representation integrated by using deep learning is achieved. Particularly, correlation between two modes can be more effectively described.

The speech recognition learning method and the speech recognition method according to the aforementioned embodiments employ an early integration scheme of acquiring a feature vector by integrating at least two or more of acoustic features, 2D features, and 3D geometric information or information derived from the 3D geometric information before recognition and performing recognition. The early integration scheme is a feature integration method of integrating two features in a feature level. It is preferable to find features invulnerable to a noisy environment among two features after extracting image and acoustic features and generate an integrated feature of the image and acoustic features.

The early integration scheme has an advantage of reducing the dimension of feature vectors while clarifying the information on images and acoustic features invulnerable to a nosy environment.

On the other hand, unlike the above-described early integration scheme, a late integration scheme in which, after performing speech recognition based on acoustic features and speech recognition based on image features, an integrated recognition result is obtained by integrating the two recognition results with weight factors based on SNR may be applied to the speech recognition method. The late integration scheme has an advantage of performing recognition by selecting recognition methods suitable for respective visual and acoustic signals.

A speech recognition method employing a late integration scheme according to an embodiment is to integrate a result of first speech recognition using 3D geometric information on a physical object correlated to or dependent on speech or information derived from the 3D geometric information and a result of second speech recognition using 2D features extracted from 2D image of the physical object and to perform speech recognition. The recognition integration scheme can provide an integrated recognition result obtained by integrating a first recognition result and a second recognition result with weighting factors based on SNR.

A speech recognition method employing a late integration scheme according to another embodiment is to integrate a result of first speech recognition using 3D geometric information on a physical object correlated to or dependent on speech or information derived from the 3D geometric information and a result of second speech recognition using acoustic features extracted from acoustic signal externally input and to perform speech recognition.

A speech recognition method employing a late integration scheme according to still another embodiment is to integrate a result of first speech recognition using 3D geometric information on a physical object correlated to or dependent on speech or information derived from the 3D geometric information, a result of second speech recognition using 2D features extracted from 2D image of the physical object, and a result of third speech recognition using acoustic features extracted from acoustic signal externally input and to perform speech recognition.

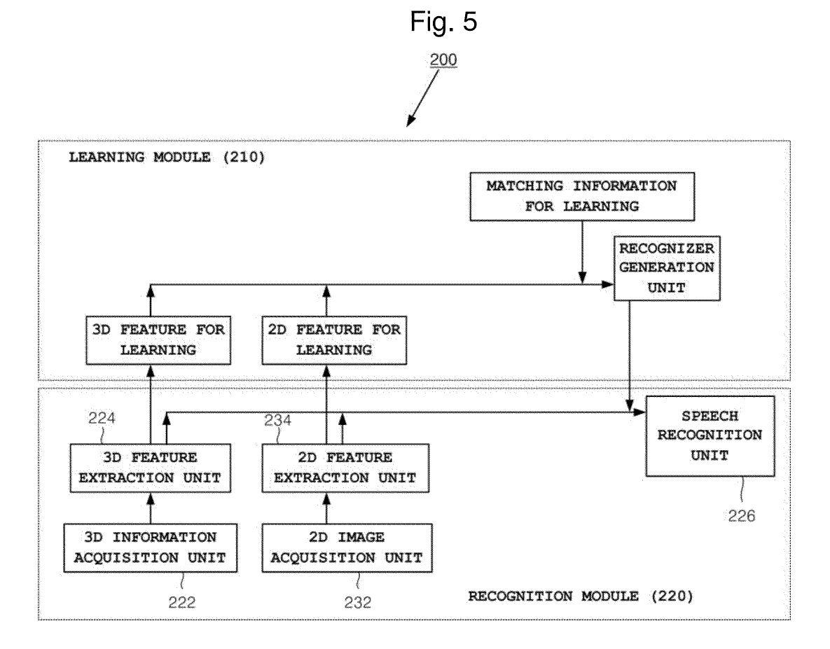

FIGS. 5 to 13 are diagrams illustrating examples of speech recognition systems embodied by using the aforementioned speech recognition learning method and the aforementioned speech recognition method.

Referring to FIG. 5, a speech recognition system 200 is configured to include a learning module 210 and a recognition module 220. The learning module 210 generates a feature vector for learning by integrating 2D features for learning and 3D features for learning and generates a recognizer by using the feature vector for learning and matching information for learning. The recognition module 220 generates a feature vector by integrating 3D geometric information on a physical object correlated to or dependent on speech or information derived from the 3D geometric information and 2D features extracted from 2D image of the physical object and performs speech recognition by applying the feature vector to the recognizer.

The recognition module 220 is configured to include a 3D information acquisition unit 222 which acquires the 3D geometric information on the physical object, a 3D feature extraction unit 224 which extracts information from the 3D geometric information acquired by the 3D information acquisition unit, a 2D image acquisition unit 232 which acquires the 2D image of the physical object, a 2D feature extraction unit 234 which extracts the 2D features from the acquired 2D image, and a speech recognition unit 226 which generates a feature vector by integrating the extracted the 2D and 3D features and performs speech recognition by applying the feature vector to the recognizer.

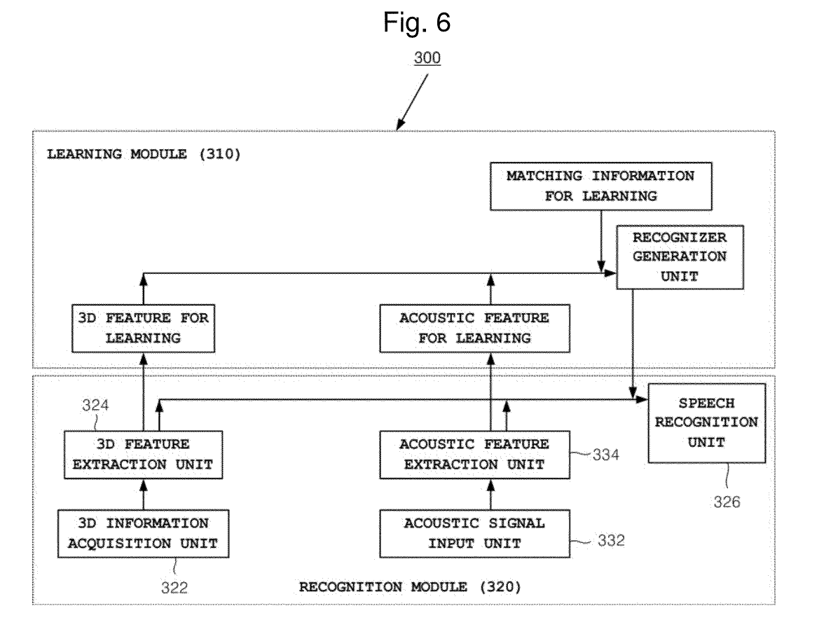

Referring to FIG. 6, a speech recognition system 300 is configured to include a learning module 310 and a recognition module 320. The learning module 310 generates a feature vector for learning by integrating acoustic features for learning and 3D features for learning and generates a recognizer by using the feature vector for learning and matching information for learning. The recognition module 320 generates a feature vector by integrating 3D features extracted from 3D geometric information on the physical object and acoustic features extracted from acoustic signal externally input and performs speech recognition by applying the generated feature vector to the recognizer.

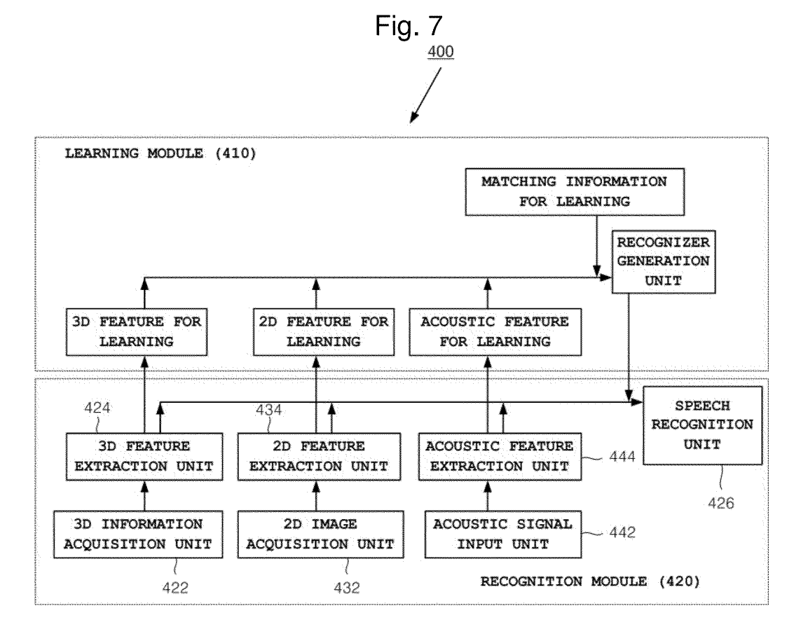

Referring to FIG. 7, a speech recognition system 400 is configured to include a learning module 410 and a recognition module 420. The learning module 410 generates a feature vector for learning by integrating acoustic features for learning, 2D features for learning, and 3D features for learning and generates a recognizer by using the feature vector for learning and matching information for learning. The recognition module 420 generates a feature vector by integrating 3D geometric information on a physical object correlated to or dependent on speech or information extracted from the 3D geometric information, 2D features extracted from 2D image of the physical object, and acoustic features extracted from acoustic signal externally input and performs speech recognition by applying the feature vector to the recognizer.

The recognition module 420 is configured to include a 3D information acquisition unit 422 which acquires the 3D geometric information on the physical object, a 3D feature extraction unit 424 which extracts information from the 3D geometric information acquired by the 3D information acquisition unit, a 2D image acquisition unit 432 which acquires the 2D image of the physical object, a 2D feature extraction unit 434 which extracts the 2D features from the acquired 2D image, an acoustic signal input unit 442 which receives the acoustic signal as external inputs, an acoustic feature extraction unit 444 which extracts the acoustic features from the input acoustic signal, and a speech recognition unit 426 which generates a feature vector by integrating the extracted acoustic features, the extracted 2D features, and the 3D geometric information or the information extracted from the 3D geometric information and performs speech recognition by applying the feature vector to the recognizer.

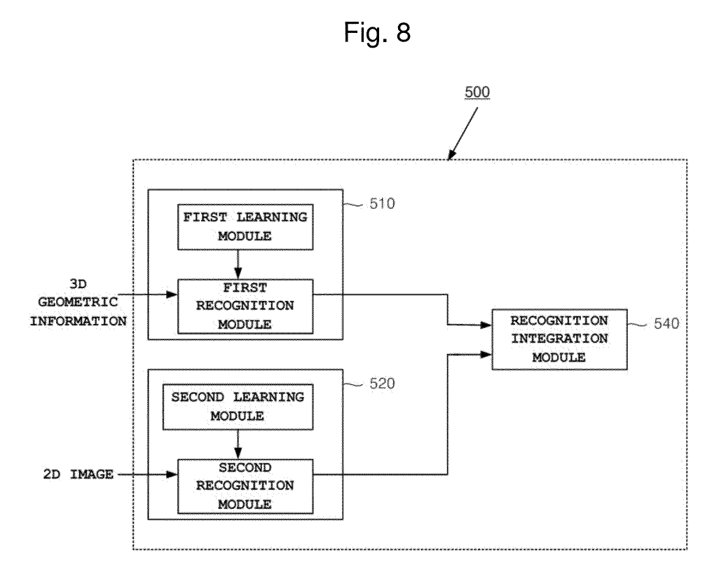

Referring to FIG. 8, a speech recognition system 500 is configured to include a first recognition module 510, a second recognition module 520, and a recognition integration module 540.

The first recognition module 510 performs speech recognition by using 3D features extracted from 3D geometric information on a physical object correlated to or dependent on speech; the second recognition module 520 performs speech recognition by using 2D features extracted from 2D image of the physical object; and the recognition integration module 540 finally determines speech by using a recognition result of the first recognition module and a recognition result of the second recognition module.

The first recognition module is configured to include a first learning module which extracts 3D features for learning from the 3D geometric information for learning and generates a first recognizer by using the 3D features for learning and matching information for learning and a first recognition module which extracts 3D features from the 3D geometric information on the physical object and performs speech recognition by applying the extracted 3D features to the first recognizer.

The second recognition module is configured to include a second learning module which extracts the 2D features for learning from the 2D image for learning and generates a second recognizer by using the extracted 2D features for learning and matching information for learning and a second recognition module which extracts the 2D features from the 2D image of the physical object and performs speech recognition by applying the extracted 2D features to the second recognizer.

The recognition integration module 540 generates an integrated recognition result by integrating a recognition result of the first recognition module and a recognition result of the second recognition module with weighting factors based on SNR.

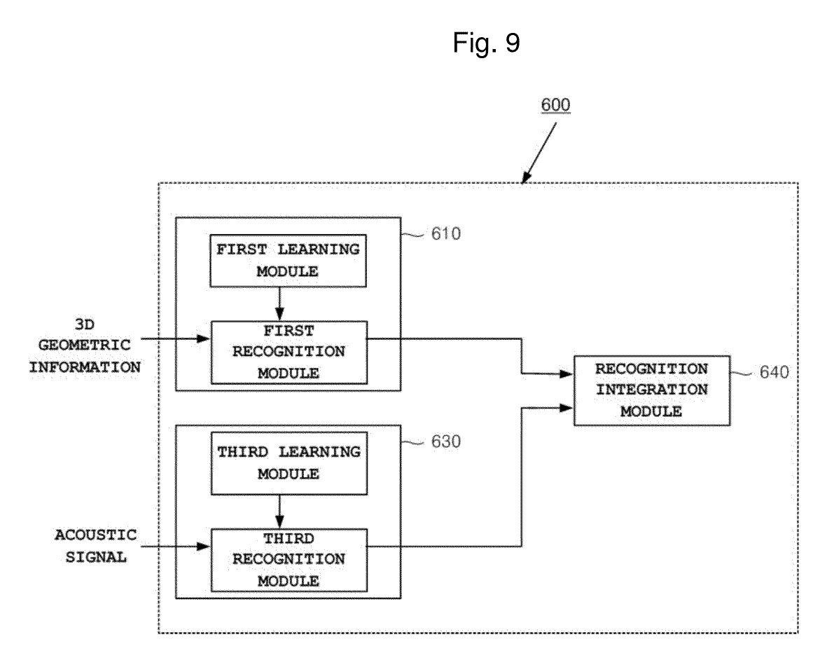

Referring to FIG. 9, a speech recognition system 600 is configured to include a first recognition module 610, a third recognition module 630, and a recognition integration module 640.

The first recognition module 610 performs speech recognition by using 3D features extracted from 3D geometric information on a physical object correlated to or dependent on speech; the third recognition module 630 performs speech recognition by using acoustic features extracted from acoustic signal externally input; and the recognition integration module 640 finally determines speech by using a recognition result of the first recognition module and a recognition result of the third recognition module.

The third recognition module 630 is configured to include a third learning module which extracts acoustic features for learning from acoustic signal for learning and generates a third recognizer by using the acoustic features for learning and matching information for learning and a third recognition module which extracts the acoustic features from the acoustic signal externally input and performs speech recognition by applying the extracted acoustic features to the third recognizer.

The recognition integration module 640 generates an integrated recognition result by integrating a recognition result of the first recognition module and a recognition result of the third recognition module with weighting factors based on SNR.

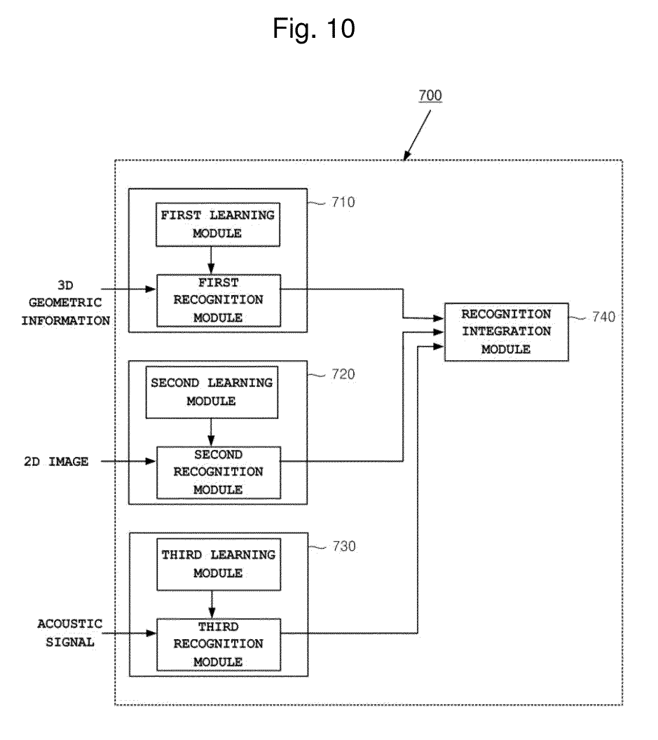

Referring to FIG. 10, a speech recognition system 700 is configured to include a first recognition module 710, a second recognition module 720, a third recognition module 730, and a recognition integration module 740.

The first recognition module 710 performs speech recognition by using 3D features extracted from 3D geometric information on the physical object; the second recognition module 720 performs speech recognition by using 2D features extracted from 2D image of a physical object; third recognition module 730 performs speech recognition by using acoustic features extracted from acoustic signal externally input; and the recognition integration module 740 finally determines speech by using a recognition result of the first recognition module, a recognition result of the second recognition module, and a recognition result of the third recognition module.

The recognition integration module 740 generates an integrated recognition result by integrating the recognition result of the first recognition module, the recognition result of the second recognition module, and the recognition result of the third recognition module with weighting factors based on SNR.

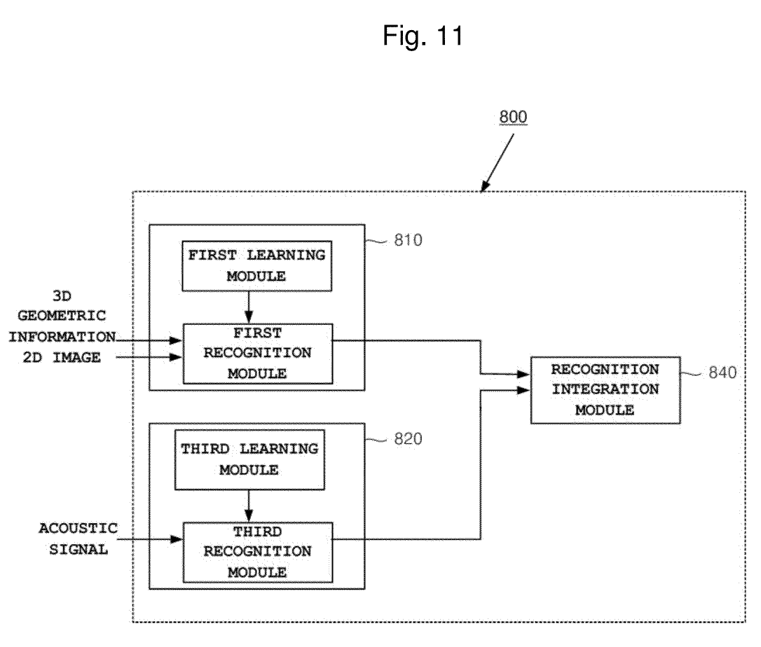

Referring to FIG. 11, a speech recognition system 800 is configured to include a first recognition module 810, a third recognition module 830, and a recognition integration module 840.

The first recognition module 810 performs speech recognition by using 3D features extracted from 3D geometric information on a physical object correlated to or dependent on speech and 2D features extracted from 2D image of the physical object; the third recognition module 830 performs speech recognition by using acoustic features extracted from acoustic signal externally input; and the recognition integration module 840 finally determines speech by using a recognition result of the first recognition module and a recognition result of the third recognition module.

The first recognition module 810 is configured to include a first learning module which generates a feature vector for learning by extracting 2D features for learning from 2D image for learning, extracting 3D features for learning from 3D geometric information for learning, and integrating the 2D features for learning and the 3D features for learning and generates a first recognizer by using the feature vector for learning and matching information for learning and a first recognition module which generates a feature vector by extracting the 3D features from the 3D geometric information on the physical object, extracting the 2D features from the 2D image of the physical object and integrating the extracted 2D and 3D features and performs speech recognition by applying the feature vector to the first recognizer.

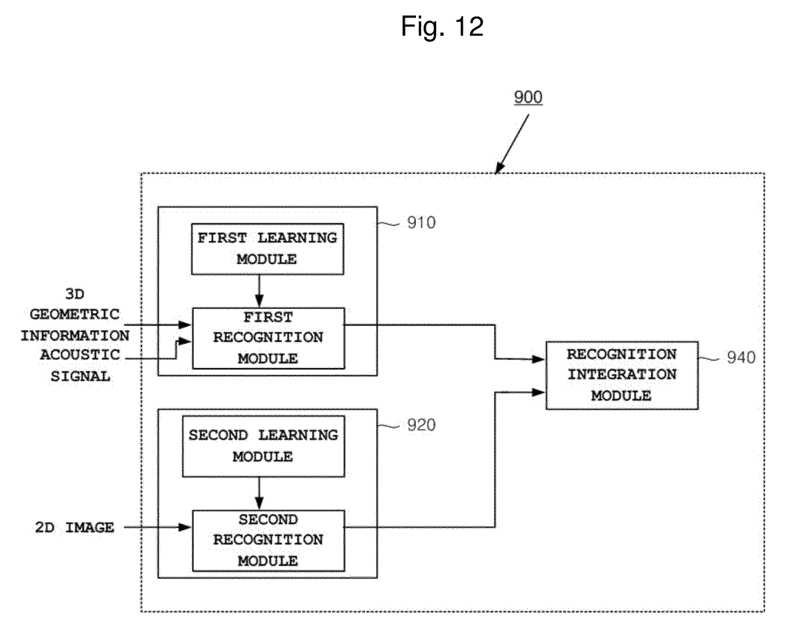

Referring to FIG. 12, a speech recognition system 900 is configured to include a first recognition module 910, a second recognition module 920, and a recognition integration module 940.

The first recognition module 910 performs speech recognition by using 3D features extracted from the 3D geometric information on the physical object and the acoustic features extracted from acoustic signal externally input; the second recognition module 920 performs speech recognition by using 2D features extracted from 2D image of the physical object; and the recognition integration module 940 finally determines speech by using a recognition result of the first recognition module and a recognition result of the second recognition module.

The first recognition module 910 is configured to include: a first learning module which generates a feature vector for learning by extracting 3D features for learning from the 3D geometric information for learning, extracting acoustic features for learning from the acoustic signal for learning, and integrating the 3D features for learning and the acoustic features for learning and generates a first recognizer by using the feature vector for learning and the matching information for learning and a first recognition module which generates one feature vector by extracting 3D features from the 3D geometric information on the physical object, extracting acoustic features from the acoustic signal externally input, and integrating the extracted acoustic features and the extracted 3D features and performs speech recognition by applying the feature vector to the first recognizer.

The recognition integration module 940 generates an integrated recognition result by integrating a recognition result of the first recognition module and a recognition result of the second recognition module with weighting factors based on SNR.

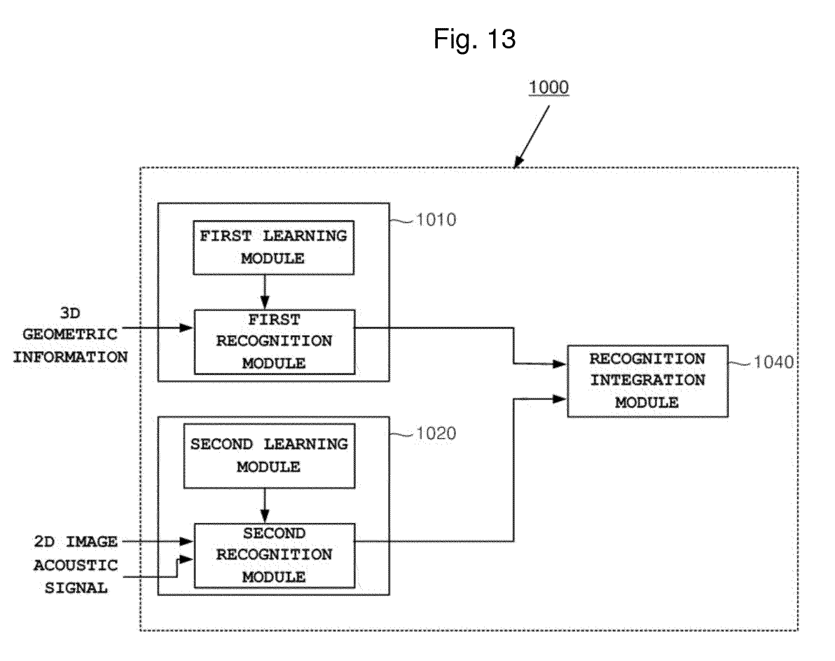

Referring to FIG. 13, a speech recognition system 1000 is configured to include a first recognition module 1010, a second recognition module 1020, and a recognition integration module 1040. The first recognition module 1010 performs speech recognition by using the 3D features extracted from the 3D geometric information on the physical object; the second recognition module 1020 performs speech recognition by using the 2D features extracted from 2D image of the physical object and the acoustic features extracted from acoustic signal externally input; and the recognition integration module 1040 finally determines speech by using a recognition result of the first recognition module and a recognition result of the second recognition module.

The second recognition module 1020 is configured to include: a second learning module which generates a feature vector for learning by extracting 2D features for learning from the 2D image for learning, extracting acoustic features for learning from the acoustic signal for learning, and integrating the extracted 2D features for learning and the extracted acoustic features for learning and generates a second recognizer by using the feature vector for learning and the matching information for learning and a second recognition module which generates one feature vector by extracting 2D features from the 2D image of the physical object, extracting acoustic features from the acoustic signal externally input, and integrating the extracted 2D features and the extracted acoustic features and performs speech recognition by applying the feature vector to the second recognizer.

The recognition integration module 1040 generates an integrated recognition result by integrating a recognition result of the first recognition module and a recognition result of the second recognition module with weighting factors based on SNR.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A speech recognition learning method comprising performing speech recognition learning by using 3D geometric information on a physical object correlated to or dependent on speech or information derived from the 3D geometric information to generate a speech recognizer,
wherein the 3D geometric information includes at least one or more of information on 3D point, information on 3D curve, and information on 3D surface.

2. The speech recognition learning method according to claim 1, wherein the performing speech recognition learning is performing the speech recognition learning by using the 3D geometric information or the information derived from the 3D geometric information and 2D features extracted from 2D image of the physical object.

3. The speech recognition learning method according to claim 1, wherein the performing speech recognition learning is performing the speech recognition learning by using the 3D geometric information or the information derived from the 3D geometric information and acoustic signal correlated to or dependent on the physical object.

4. The speech recognition learning method according to claim 1, wherein the performing speech recognition learning is performing the speech recognition learning by using the 3D geometric information or the information derived from the 3D geometric information, 2D features extracted from 2D image of the physical object, and acoustic signal correlated to or dependent on the physical object.

5. The speech recognition learning method according to claim 1, wherein the performing speech recognition learning is performing the speech recognition learning by using deep learning.

6. The speech recognition learning method according to claim wherein the performing speech recognition learning is performing the speech recognition learning by using deep learning.

7. The speech recognition learning method according to claim 3, wherein the performing speech recognition learning is performing the speech recognition learning by using deep learning.

8. The speech recognition learning method according to claim 4, wherein the performing speech recognition learning is performing the speech recognition learning by using deep learning.

9. A speech recognition method comprising performing speech recognition by applying 3D geometric information on a physical object correlated to or dependent on speech or information derived from the 3D geometric information to a speech recognizer,
wherein the 3D geometric information includes at least one or more of information on 3D point, information on 3D curve, and information on 3D, surface.

10. The speech recognition method according to claim 9, wherein the performing speech recognition is performing the speech recognition by using the 30 geometric information or the information derived from the 3D geometric information and 2D features extracted from 2D image of the physical object.

11. The speech recognition method according to claim 9, wherein the performing speech recognition is performing the speech recognition by using the 3D geometric information or the information derived from the 3D geometric information and acoustic signal correlated to or dependent on the physical object.

12. The speech recognition method according to claim 9, wherein the performing speech recognition is performing the speech recognition by using the 3D geometric information or the information derived from the 3D geometric information, 2D features extracted from 2D image of the physical object, and acoustical signal correlated to or dependent on the physical Object.

13. A speech recognition method comprising:
(a) a performing speech recognition learning by using 3D geometric information on a physical object correlated to or dependent on speech or information derived from the 3D geometric information to generate a speech recognizer; and
(b) performing speech recognition by applying 3D geometric information on a physical object correlated to or dependent on speech or the information derived from the 3D geometric information to the speech recognizer;
wherein the 3D geometric information includes at least one or more of information on 3D point, information on 3D curve, and information on 3D surface.

14. The speech recognition method according to claim 13, wherein the performing speech recognition learning is performing the speech recognition learning by using 3D geometric information on a physical object correlated to or dependent on speech or the information derived from the 3D geometric information and 2D feature extracted from 2D image of the physical object.

15. The speech recognition method according to claim 13, wherein the performing speech recognition learning is performing the speech recognition learning by using 3D geometric information on a physical object correlated to or dependent on speech or the information derived from the 3D geometric information and acoustic signal correlated to or dependent on the physical object.

16. The speech recognition method according to claim 13, wherein the performing speech recognition learning is performing the speech recognition learning by using 3D geometric information on a physical object correlated to or dependent on speech or the information derived from the 3D geometric information, 2D features extracted from 2D image of the physical object, and acoustic signal correlated to or dependent on the physical object.

17. The speech recognition method according to claim 13, wherein the performing speech recognition is performing the speech recognition by using 3D geometric information on a physical object correlated to or dependent on speech or the information derived from the 3D geometric information and 2D features extracted from 2D image of the physical object.

18. The speech recognition method according to claim 13, wherein the performing speech recognition is performing the speech recognition by using 3D geometric information on a physical object correlated to or dependent on speech or the information derived from the 3D geometric information and acoustic Signal correlated to or dependent on the physical object.

19. The speech recognition method according to claim 13, wherein the performing speech recognition is performing the speech recognition by using 3D geometric information on a physical object correlated to or dependent on speech or the in derived from the 3D, geometric information, 2D features extracted from 2D image or the physical object, and acoustic signal correlated to or dependent on the physical object.

20. The speech recognition method according to claim 13,
wherein the performing, speech recognition learning is performing the speech recognition learning by using 3D geometric information on a physical object correlated to or dependent on speech or the information derived from the 3D geometric information, 2D features extracted from 2D image of the physical object, or acoustic signal correlated to or dependent on the physical object, and
wherein the performing speech recognition is performing the speech recognition by using 3D geometric information on a physical object correlated to or dependent on speech or the information derived from the 3D geometric information, the 2D features extracted from the 2D image of the physical object, or the acoustic signal correlated to or dependent on the physical object.
